(19) United States
(12) Patent Application Publication
(10) Pub. No.: US 2005/0141806 A1
(43) Pub. Date: Jun. 30, 2005

(54) Multiplexing and demultiplexing optical signals

(76) Inventors: Nagesh K. Vodrahalli, Los Altos, CA (US); Xue-Jun Ying, San Jose, CA (US); Ruolin Li, Santa Clara, CA (US)

Correspondence Address: TROP PRUNER & HU, PC, 8554 KATY FREEWAY, SUITE 100, HOUSTON, TX, 77024, US

(21) Appl. No.: 10/751,309

(22) Filed: Dec. 31, 2003

(51) Int. Cl. G02B 6/28

(52) U.S. Cl. 385/24

(57) ABSTRACT

A multiplexer and demultiplexer may be formed so that two input wavelengths from an optically multiplexed signal may be demultiplexed. A demultiplexer may be in the form of an integrated filter and photodetector. The filter may reflect one wavelength and may pass another wavelength. The reflected wavelength is detected by a first detector and the passed wavelength is detected by a second detector. For example, the second detector may be combined with the filter by forming the filter directly on the second detector. In one embodiment, the second detector may be L-shaped.

### BACKGROUND

This invention relates generally to optoelectrical systems.

Optoelectrical systems transmit signals both by optical and electrical means. Transducers are utilized to convert optical to electrical signals and vice versa.

Commonly, light information must be converted into electrical information. In many cases, the light information may be multiplexed so that a number of different wavelengths are transmitted over the same optical fiber. For example, in wavelength division multiplexing, a large number of signals may be transmitted over the same fiber.

Thus, there is a need for ways to demultiplex the signals and/or add additional signals to the optical stream.

### BRIEF DESCRIPTION OF THE DRAWINGS

FIG. 1 is a top plan view of one embodiment of the present invention;

FIG. 2 is a partial, cross-sectional view of a portion of the embodiment shown in FIG. 1 in accordance with one embodiment of the present invention; and

FIG. 3 is an enlarged, cross-sectional view of a portion of the embodiment shown in FIG. 1 in accordance with one embodiment of the present invention.

### DETAILED DESCRIPTION

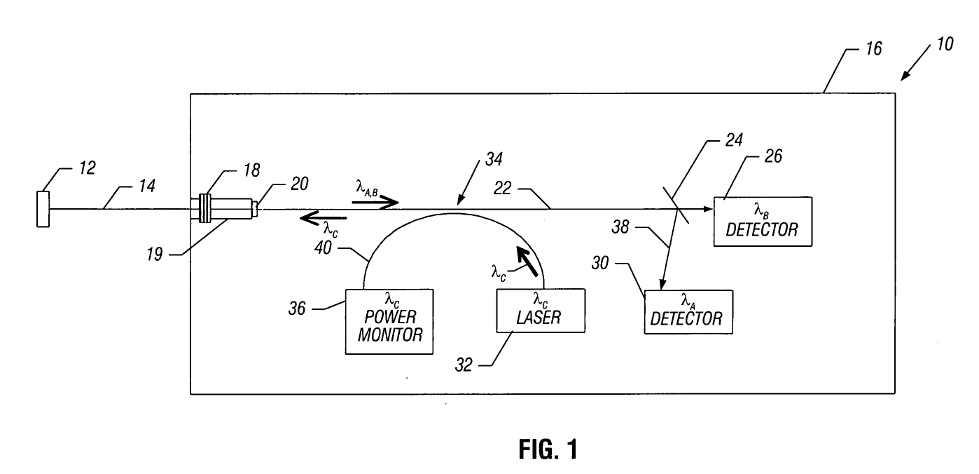

Referring to FIG. 1, an optical connector 12 may connect to an optical cable or fiber. A fiber 14 conveys a signal from the connector 12 to a silicon electrooptical bench 16. The fiber 14 may be coupled to the bench 16 through a fiber mount 18 mounted on the bench 16 so that the fiber 14 is fixed between the mount 18 and a V-shaped groove 19 formed in the upper surface of the bench 16. A fiber-waveguide interface 20 converts the signal from the fiber 14 to an appropriate form to be transmitted over a waveguide 22 formed within the bench 16.

Thus, in one embodiment, at least two wavelengths, indicated as wavelengths A and B, may be transmitted from the cable through the fiber 14 to the waveguide 22. A signal from the cable may be wavelength division multiplexed in one embodiment of the present invention. That signal passes through a coupler 34 to a filter 24. The filter 24 may pass one wavelength, such as the wavelength B. The wavelength B may then be detected by the detector 26 and connected to an electrical signal.

Another wavelength, such as the wavelength A, is not passed by the filter 24 but, instead, is reflected by it, over the path 38, to be detected by a wavelength A detector 30. The detected optical signal may be converted into an electrical signal by the detector 30.

At the same time, a laser 32 generates a signal of wavelength C which is partially transmitted over the curved waveguide 40 through the coupler 34 to a power monitor 36 for monitoring the power of the signal of wavelength C. The remainder of the wavelength C signal may be impressed onto the waveguide 22 across the coupler 34. The signal of wavelength C may be provided by the bench 16 back through the fiber 14 and the coupler 12 to the cable. As a result, two wavelengths may be removed and detected and a third wavelength may be added back to the multiplexed communication system. Of course, any number of signals may be added or removed in other embodiments. In one embodiment, the wavelengths A and B are wavelength division multiplexed wavelengths such as 1490 and 1550 nm, and the wavelength C is in a separate wavelength band such as 1310 nm.

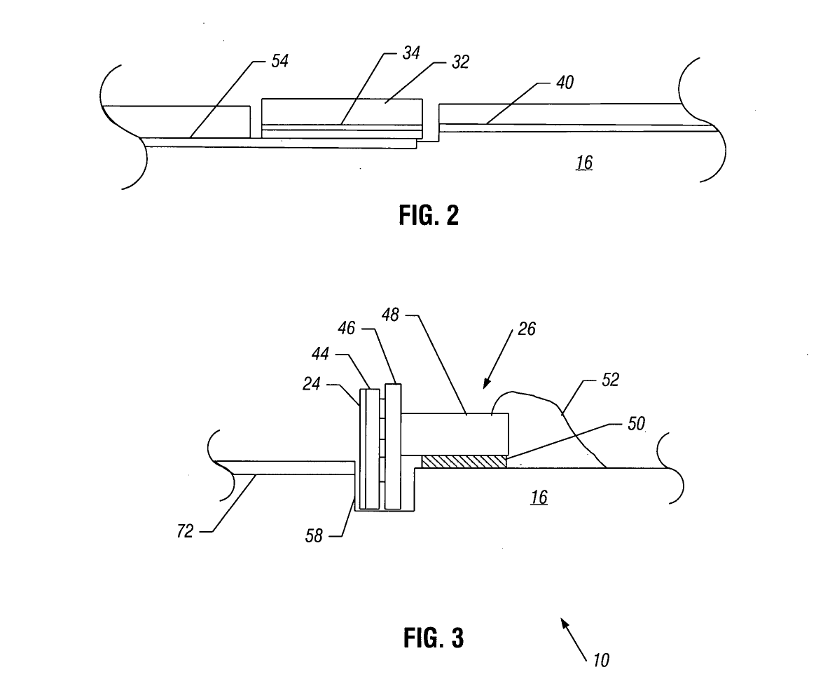

Referring to FIG. 2, the laser 32 may be arranged to be fit within a trench defined within the surface of the bench 16. The laser 32 is connected to the lead 54 by thermocompression or other bonding techniques. The laser 32 is aligned with the laser waveguide 34 adjusted to the waveguide 40 embedded in the silicon electro-optical bench 16.

The filter 24 and detector element 44 may be implemented as an integrated unit to form the detector 26 as indicated in FIG. 3. The filter 24 may be formed by a film that is secured to the photodetector element 44. The detector 26 may include an L-shaped package, including a relatively vertical portion 46 and a relatively horizontal portion 48 that may be secured to the bench 16 by an adhesive 50 in one embodiment. The detector element 44 may be secured and electrically interconnected to the L-shaped package portions 46 and 48 by thermocompression bonding in one embodiment, or by solder in another embodiment. Alternatively, wire bonding may also be utilized for the electrical connection, with adhesive for the mechanical connection. In one embodiment, the portions 46 and 48 may be multilayer packages electrically connected at 90 degrees to form an L-shaped mount. The L-shaped package may be made of two multilayer packages connected at ninety degrees by brazing or soldering. The second multilayer package provides easy access for the electrical connections to the silicon electrooptical bench 16. As another embodiment, the L-shaped mount may be formed of a lead frame instead of a second multilayer package that may be soldered down onto the silicon optical bench at ninety degrees.

Electrical signals may be coupled to and from the detector 26 as indicated by the wire bond 52.

In one embodiment, the filter 24 may be formed of a conventional, commercially available, thin film filter component. Such thin film filters may have alternate layers of appropriate thin films like Al₂O₃, TiO₂, SiO₂, etc., which may be deposited on an appropriate substrate, such as a glass substrate. The filter 24 may be adhesively secured on the photodetector element 44 by way of an optical adhesive in one embodiment.

In some embodiments, the integrated structure may be advantageous since a separate pick and place operation for placing the thin film filter and for placing the detector 26 may be avoided.

A second approach may be to directly deposit alternate layers of appropriate thin films on the photodetector element 44. Of course, this deposition may be done while the photodetector element 44 is still in the wafer format. This approach may be advantageous, in some embodiments, as it may decrease optical losses by eliminating the thickness of the glass substrate that is found in commercial thin film filters.

The detector 26 detects the wavelength that is transmitted through the thin film filter 24. The reflected wavelength is coupled to the path 38 in the silicon electrooptical bench 16. As the optical angle of incidence at the detector 26 may be important to make sure the losses are reduced, a precision trench sidewall 58 may be used for reference during assembly in some embodiments. After the filter detector hybrid is picked and placed, it is slid to the sidewall of the trench 58 to couple to the waveguide 72. The base of the trench 58 serves as the bottom reference plane for alignment and provides stability during the pick and place operations. To provide mechanical robustness, the gap between the filter detector hybrid may be filled using optical epoxy on the waveguide side, and on the non-active side as well, as needed.

The L-mount arrangement may facilitate electrical connections from the detector 26 that are in the vertical plane and may transfer them to the horizontal plane on top of the silicon optical bench 16, essentially providing a ninety degree bend for electrical connections. On the horizontal plane, electrical connections to the silicon optical bench may be made using wire bonding or solder bonding.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
demultiplexing at least two wavelengths from a multiplexed optical signal;
detecting each of said demultiplexed wavelengths; and
generating a third wavelength to multiplex on said multiplexed optical signal.

2. The method of claim 1 including providing an angled reflector in the path of said multiplexed signal to reflect light of a first wavelength to a first detector and to pass light of a second wavelength.

3. The method of claim 1 including receiving said multiplexed optical signal over a waveguide and impressing said third wavelength on said waveguide.

4. The method of claim 1 wherein demultiplexing includes providing an integrated reflector with a detector of a first wavelength of said at least two wavelengths.

5. The method of claim 4 including providing an L-shaped detector.

6. The method of claim 5 including forming said detector on an electrooptical bench.

7. The method of claim 6 including providing a trench in said bench to receive a portion of said L-shaped detector.

8. The method of claim 6 including forming said reflector on the surface of said detector.

9. The method of claim 8 including forming said reflector by coating alternate layers of material on said detector.

10. The method of claim 8 including using said trench to position said detector on said bench.

11. The method of claim 7 including forming electrical connections from said bench to one portion of said L-shaped detector.

12. An optical system comprising:
a waveguide;
a demultiplexer coupled to said waveguide to demultiplex at least two wavelengths from a multiplexed optical signal on said waveguide, said demultiplexer including photodetectors to detect each of said wavelengths; and
a multiplexer coupled to said waveguide to multiplex an optical signal of a third wavelength onto said waveguide.

13. The system of claim 12 wherein said demultiplexer includes an angled reflector to reflect light of a first wavelength to a first detector and to pass light of a second wavelength.

14. The system of claim 12 wherein said multiplexer includes a laser coupled to a curved waveguide, said curved waveguide having a portion arranged proximately to said waveguide.

15. The system of claim 14 wherein said laser is coupled at one end of said curved waveguide and a power monitor is coupled to the other end of said curved waveguide.

16. The system of claim 12 wherein said demultiplexer includes an integrated reflector and photodetector, said photodetector to detect a wavelength passed by said reflector.

17. The system of claim 16 wherein said integrated reflector and detector includes an L-shaped detector.

18. The system of claim 17 wherein said demultiplexer, said multiplexer, and said waveguide are formed on a planar substrate including a trench to receive one arm of said L-shaped detector.

19. The system of claim 18 wherein said reflector is formed on the surface of said photodetector.

20. The system of claim 19 wherein said reflector includes a plurality of layers of material coated on said detector.

21. A photodetector comprising:
an L-shaped body; and
an optical reflector on one surface of said body to reflect one wavelength and to transmit another wavelength.

22. The photodetector of claim 21 wherein said reflector includes at least two layers on said surface.

23. The photodetector of claim 21 wherein said photodetector includes two portions arranged at approximately 90 degrees to one another, each of said portions being formed of multilayer packages.

24. The photodetector of claim 21 wherein said L-shaped body may be formed of a multilayer package and a lead frame.

25. The photodetector of claim 21 wherein said reflector includes a layer of filter material that filters out one wavelength and a layer of reflector that reflects another wavelength.
